(19) United States
(12) Patent Application Publication
(10) Pub. No.: US 2018/0087305 A1
(43) Pub. Date: Mar. 29, 2018

(54) EJECTION DEVICE FOR A MOVABLE FURNITURE PART

(71) Applicant: Julius Blum GmbH, Hoechst (AT)

(72) Inventor: Fredi DUBACH, Baeretwil (CH)

(21) Appl. No.: 15/830,550

(22) Filed: Dec. 4, 2017

Related U.S. Application Data
(63) Continuation of application No. PCT/AT2016/050143, filed on May 17, 2016.

(30) Foreign Application Priority Data
Jun. 9, 2015 (AT) A 361/2015

(51) Int. Cl. E05F 1/08; E05F 1/10; E05F 1/16; A47B 88/463

(52) U.S. Cl. CPC E05F 1/08; E05F 1/10; E05Y 2900/20; A47B 88/463; E05F 1/16

(57) ABSTRACT

An ejection device includes a support formed as a housing; an ejection element for ejecting the movable furniture part from a closed position into an open position along an ejection path; an ejection force accumulator which applies a force to the ejection element in the opening direction of the movable furniture part; and a clamping device for clamping the ejection force accumulator. The clamping device has a clamping element to be coupled to the movable furniture part, and a movement transmission element, in particular a rotatable movement transmission element, between the clamping element and the ejection element. The clamping element and the ejection element can be moved in opposite directions when coupled by the movement transmission element when the ejection force accumulator is clamped, and the ejection element, the movement transmission element, and the clamping element are moveable together relative to the support over a first part of the ejection path.

The invention concerns an ejection device for a movable furniture part, comprising a carrier, in particular formed as a housing, an ejection element for ejecting the movable furniture part from a closed position into an open position (along an ejection path, an ejection force storage member force-actuating the ejection element in the opening direction of the movable furniture part, wherein the ejection force storage member on the one hand engages the carrier and on the other hand engages the ejection element, and a tensioning device for tensioning the ejection force storage member, wherein the tensioning device comprises a tensioning element, which can be coupled to the movable furniture part, and a, in particular rotatable, movement transmission element between the tensioning element and the ejection element, wherein the tensioning element and the ejection element can be moved in opposite directions in a coupled manner by the movement transmission element when the ejection force storage member is tensioned. Moreover, the invention concerns an item of furniture with a furniture carcass, a movable furniture part and such an ejection device for the movable furniture part.

Already since many years ejection devices for movable furniture as for example drawers, furniture doors or furniture flaps are known in the industrial sector of furniture fittings. Such ejection devices are also often referred to as touch-latch-mechanisms or as tip-on-mechanisms.

An example for such an ejection device is disclosed in the WO 2013/134798 A1 of the applicant. Especially in the last embodiment of this document it is disclosed that a tensioning device for tensioning the ejection force storage member is provided, wherein the tensioning element is pulled via a magnet by the movable furniture when opening. This movement of the tensioning element in the opening direction is being converted into a movement of the ejection element in the opposite direction by a movement transmission element in the form of a gear wheel. As a consequence, the ejection force storage member is loaded by means of the tensioning device when pulling the movable furniture part. In this ejection device the rotatable movement transmission element always remains on the same position, whereby—in order to load ejection force storage member—relative large paths have to be travelled by the tensioning element.

The object of the present invention, thus, is to provide an alternative or improved ejection device compared to the prior art.

This is solved by an ejection device with the features of claim 1. Hence, according to the invention it is provided that the ejection element, the movement transmission element and the tensioning element can be moved together relative to the carrier at least over a first part of the ejection path. Thus, a part of the movement path to be carried out during the tensioning movement can already be travelled in common by these three components. No decoupling between these three components has to be carried out too. In addition, two elements, namely the ejection element and the tensioning element, do not have to project from the carrier of from the housing of the ejection device as it is the case in the prior art.

Preferred embodiments of the present invention are generally indicated in the sub-claims. So it is basically possible that the common movement of the movement transmission element, the tensioning element and the ejection element is only relative short or is carried out only over a part of the ejection path of the ejection element. Preferably, however, it is provided that the ejection element, the movement transmission element and the tensioning element can be moved together relative to the carrier over the whole ejection path.

For a simple possibility of the common movement it is preferably provided that the ejection element, the movement transmission element and the tensioning element are, preferably linearly, displaceable together along a guide track formed in the carrier and comprising two end abutments. In order to carry out the tensioning of the ejection force storage member as exactly as possible, it is preferably provided that the movement transmission element abuts an end abutment of the guide track when the ejection force storage member is tensioned.

Basically it is possible that the movement transmission element is for example constructed in the form of a lever mechanism or in another manner. For a simpler and safer construction it is preferably provided that the movement transmission element is formed as a gear wheel. Suitable for this embodiment it is additionally provided in a preferred manner that the tensioning element and the ejection element each comprise a gear rack. Thus, it is preferably provided that, when the ejection force storage member is tensioned, the gear rack of the tensioning element and the gear rack of the ejection element mesh with the movement transmission element formed as a gear wheel and are movable, preferably in the form of a 1:1-transmission ratio, in opposite directions in a coupled manner by the movement transmission element. Therefore, a secure transmission of the tensioning movement to the ejection force storage member is guaranteed.

In order to guarantee that, after the tensioning of the ejection force storage member, the tensioning element is not projecting from the furniture carcass until the movable furniture part is closed again, preferably a retrieving device for moving the tensioning element in a retrieved position is provided, wherein the retrieving device comprises a retrieving element, which can be coupled to the tensioning element, and a retrieving force storage member force-actuating the retrieving element. In principle, this retrieving device can be formed separately from the rest of the ejection device. In order to use as few components as possible, however, it is preferably provided that the retrieving element is integrally formed with the movement transmission element. Thus, this movement transmission element has a double function, namely when tensioning the ejection force storage member and when retrieving the tensioning element. For that purpose, it is particularly preferred that the retrieving element comprises a slider and the movement transmission element formed as a gear wheel and being rotatably supported in the slider. In the case of this compact construction it is provided in the same manner as with the tensioning device that the retrieving element is displaceably supported in a limited manner in the guide track comprising two end abutments and formed in the carrier.

For the general function of the ejection device it shall not be excluded that the ejection force storage member is being tensioned by means of the tensioning device when closing the movable furniture part. In order to use the active additional opening movement anyhow mostly carried out after the ejection by a user, it is preferably provided that the ejection force storage member can be tensioned by the tensioning device when pulling the movable furniture part in the opening direction, preferably along a tensioning path subsequent to the ejection path.

In order to prevent an undesired triggering of the ejection device, a locking device for locking the ejection element in a locking position is preferably provided, wherein the locking device can be unlocked by over-pressing the movable furniture part into an over-pressed position located behind the closed position. In this case, the locking can be effected for example on the basis of the ballpoint-pen-principle, by means of friction surfaces or by similar variants. Preferably it is provided that the locking device comprises a, preferably cardioid-shaped, sliding guide track formed in the carrier, a control lever movably, preferably rotatably, supported on the ejection element and a control pin arranged on the control lever and engaging the sliding guide track.

Furthermore, protection is sought for an item of furniture with a furniture carcass, a movable furniture part and an ejection device according to the invention for the movable furniture part. In this case, it is irrelevant whether the ejection device itself is arranged on the movable furniture part and is repelling from the furniture carcass or whether the ejection device is arranged on the furniture carcass and actively ejects the movable furniture part into the opening direction. The basic function principle remains the same for both variants. Such an ejection device can be preferably combined with a, preferably damped, retraction device too. Thus, not only a simple ejection by pressing onto the movable furniture part is possible, but the movable furniture part is also being actively retracted in closing direction on the last centimeters or millimeter of the closing path. For example, such a retraction device can be integrated in a hinge of a furniture door. The ejection device and the retraction device can be but do not have to be integrated in one construction unit.

Further details and advantages of the present invention are described more fully hereinafter by means of the specific description with reference to the embodiments illustrated in the drawings, in which:

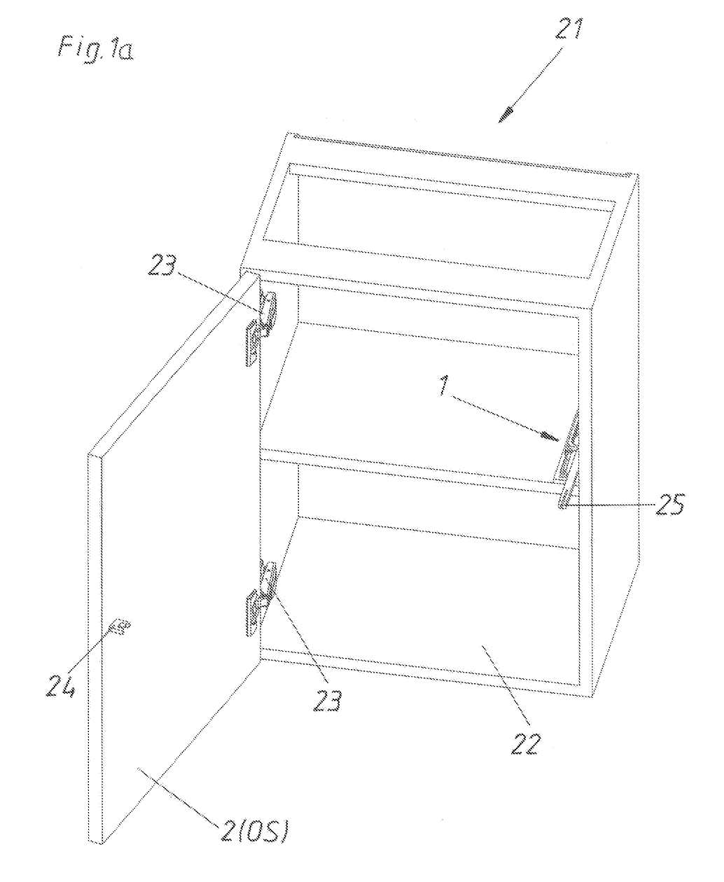

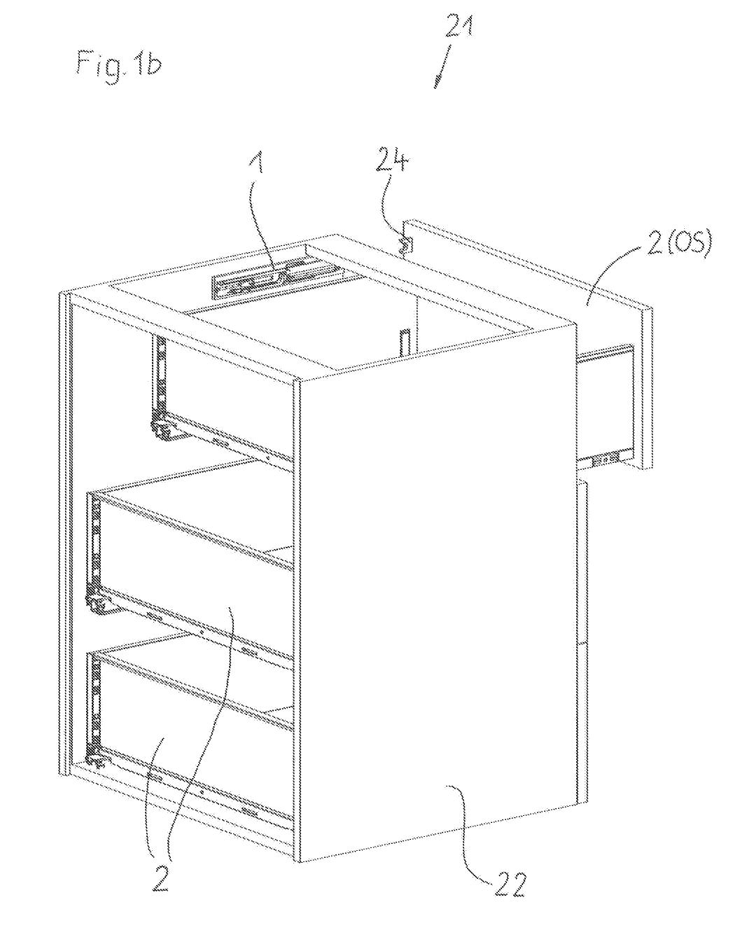

FIG. 1a shows a perspective view of an item of furniture with a furniture door and an ejection device,

FIG. 1b shows a perspective view of an item of furniture with three drawers and an ejection device each,

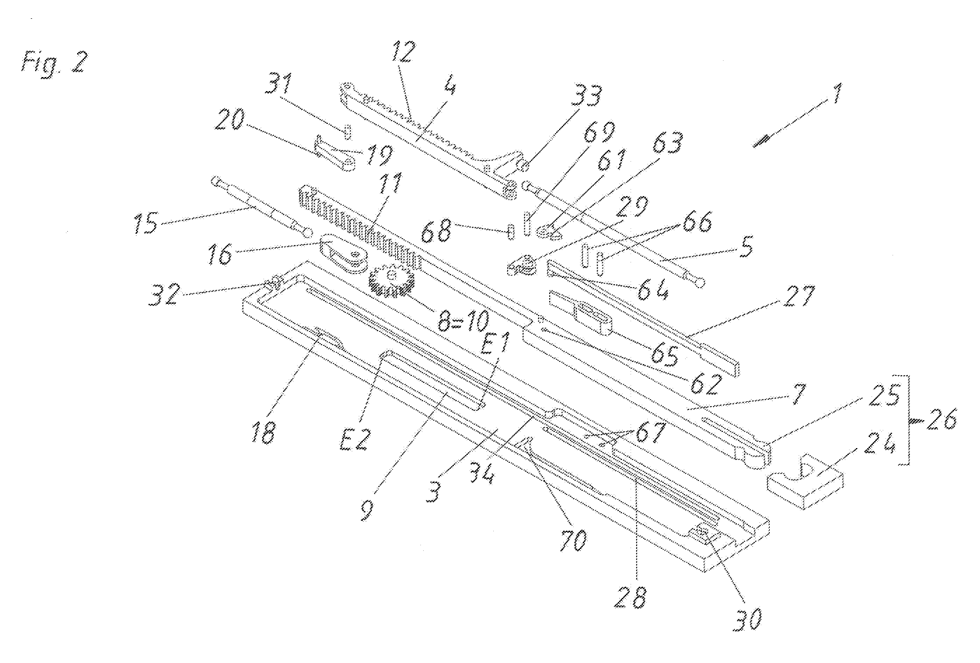

FIG. 2 shows this ejection device in an exploded view,

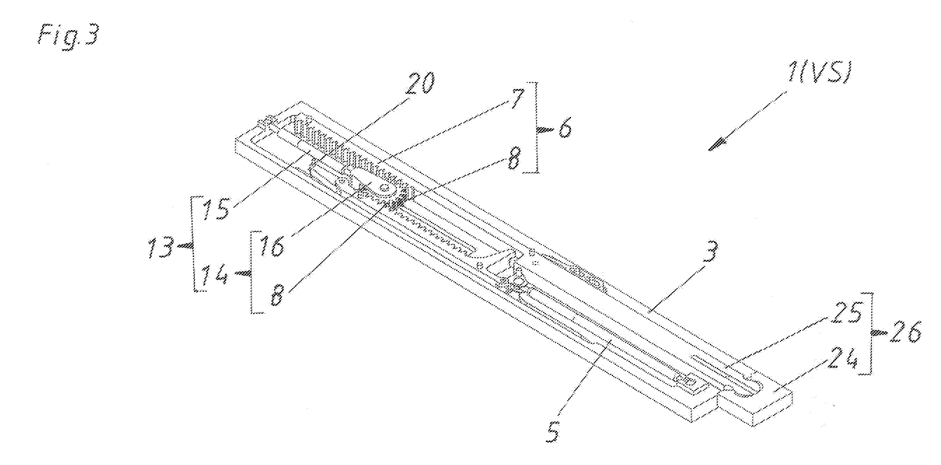

FIG. 3 shows a perspective view of the assembled ejection device,

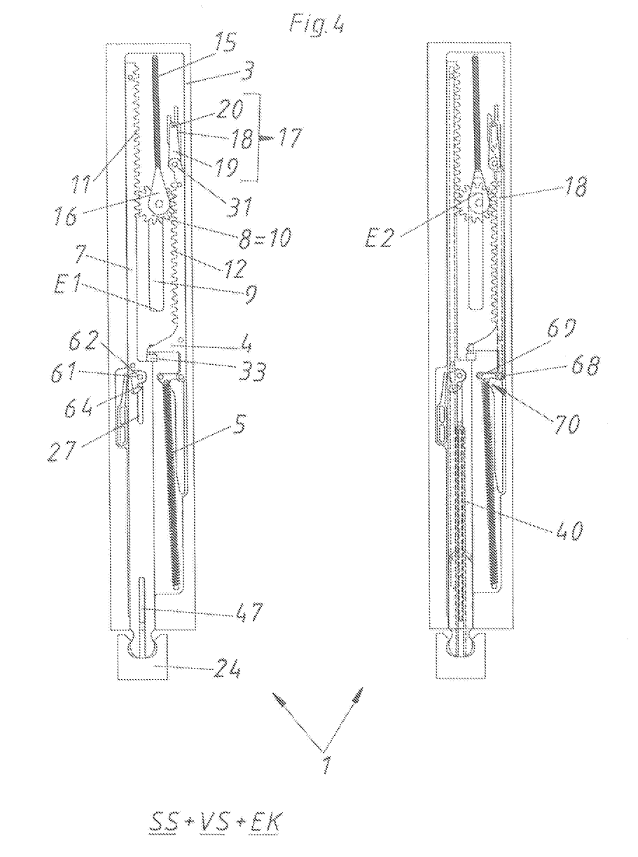

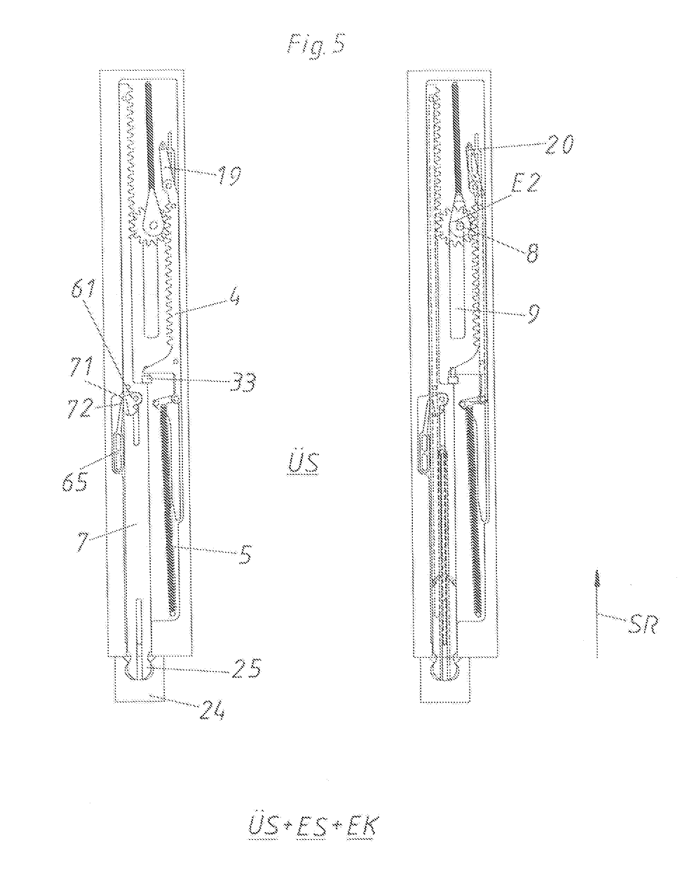

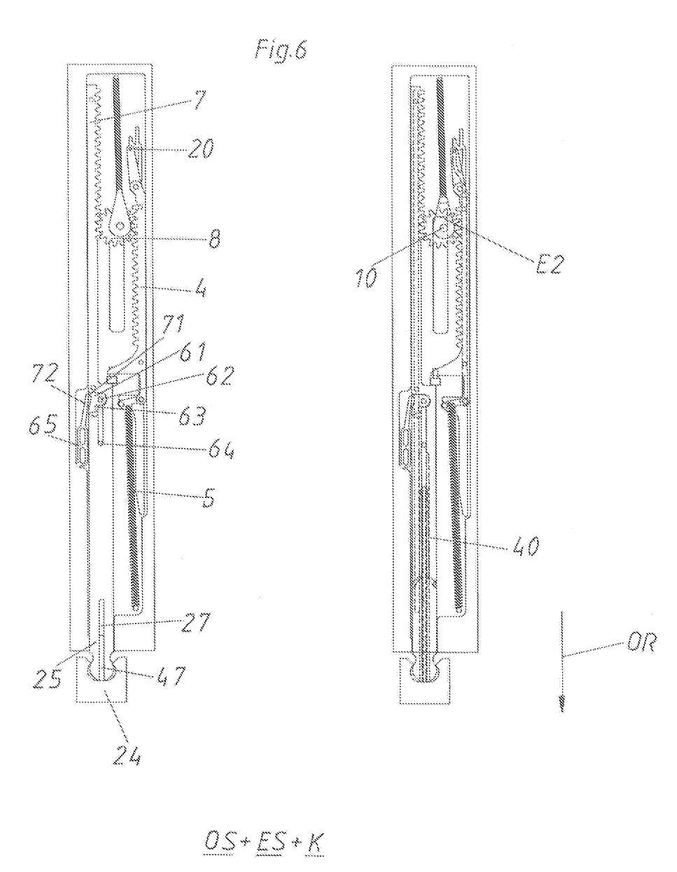

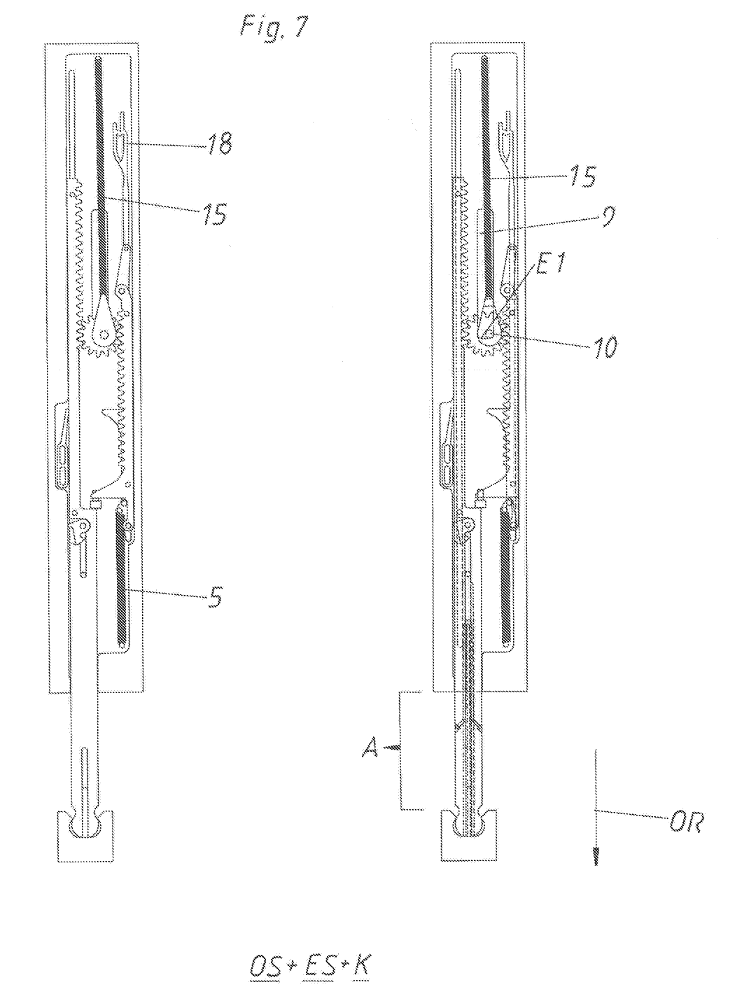

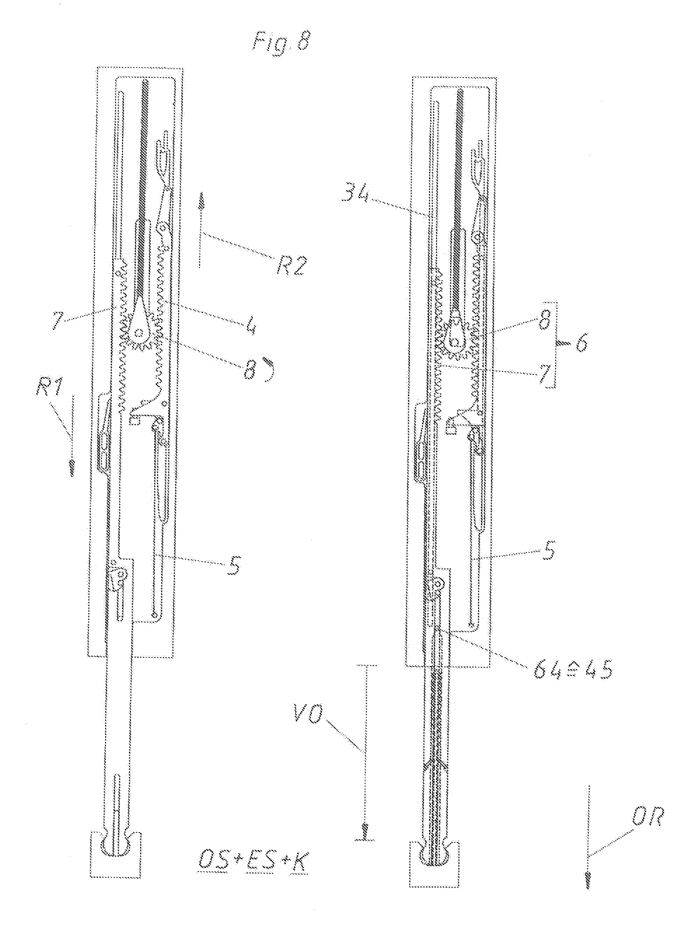

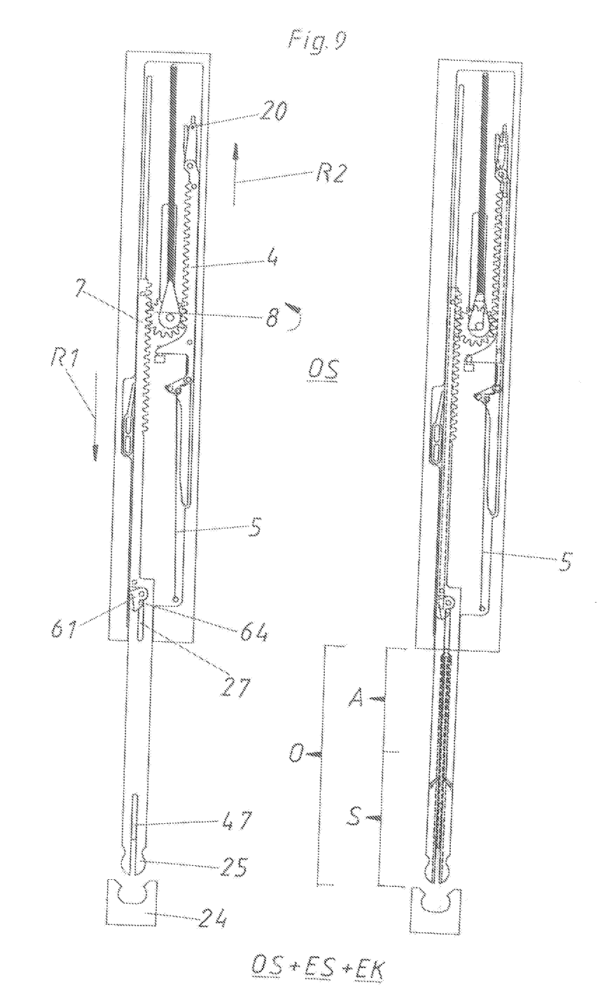

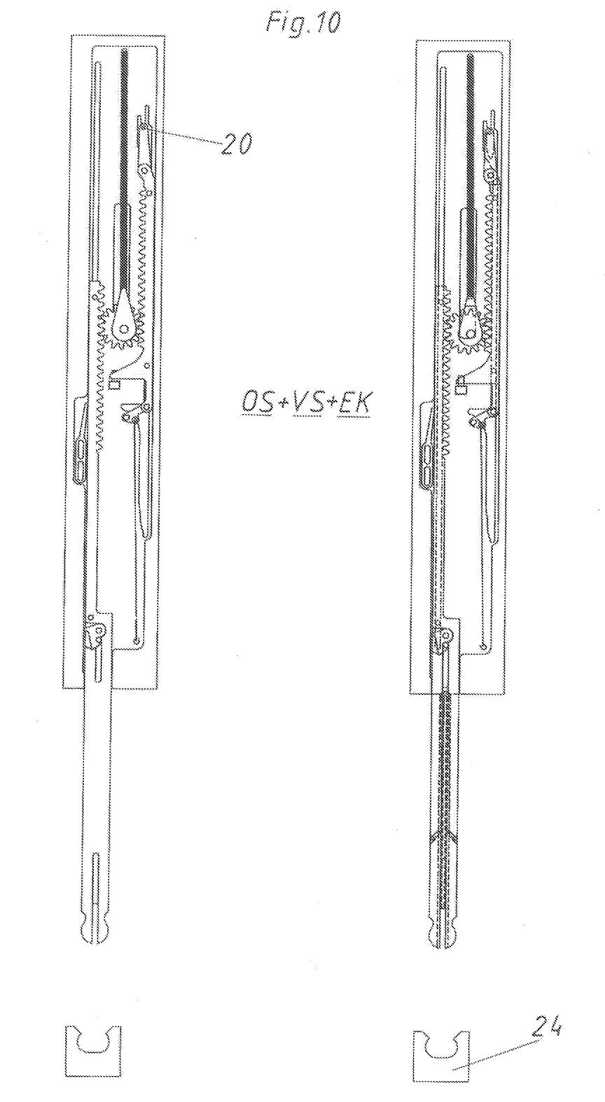

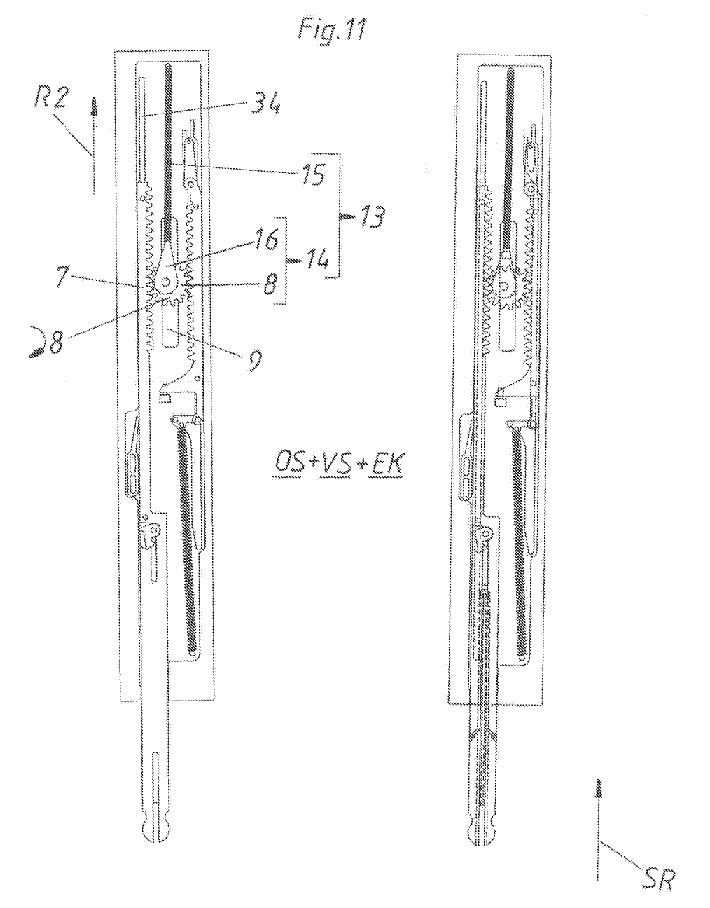

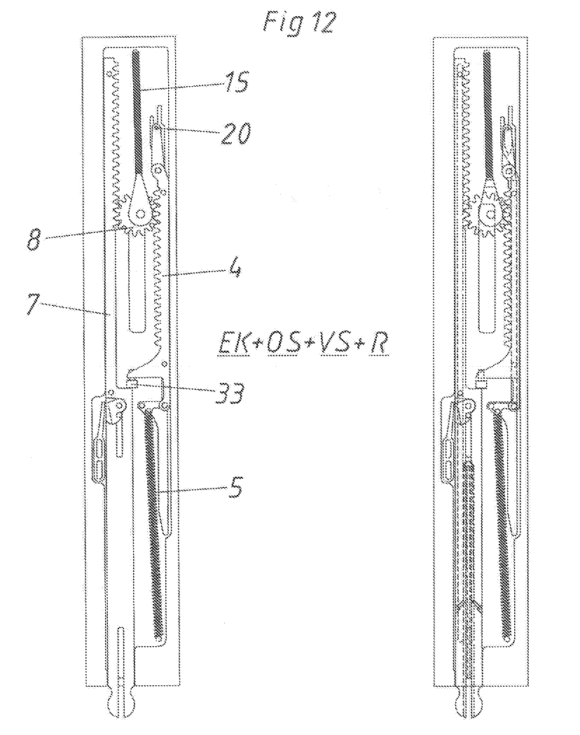

FIGS. 4 to 12 show in a top view the movement sequence of the ejection device during the ejection, tensioning and retrieving and

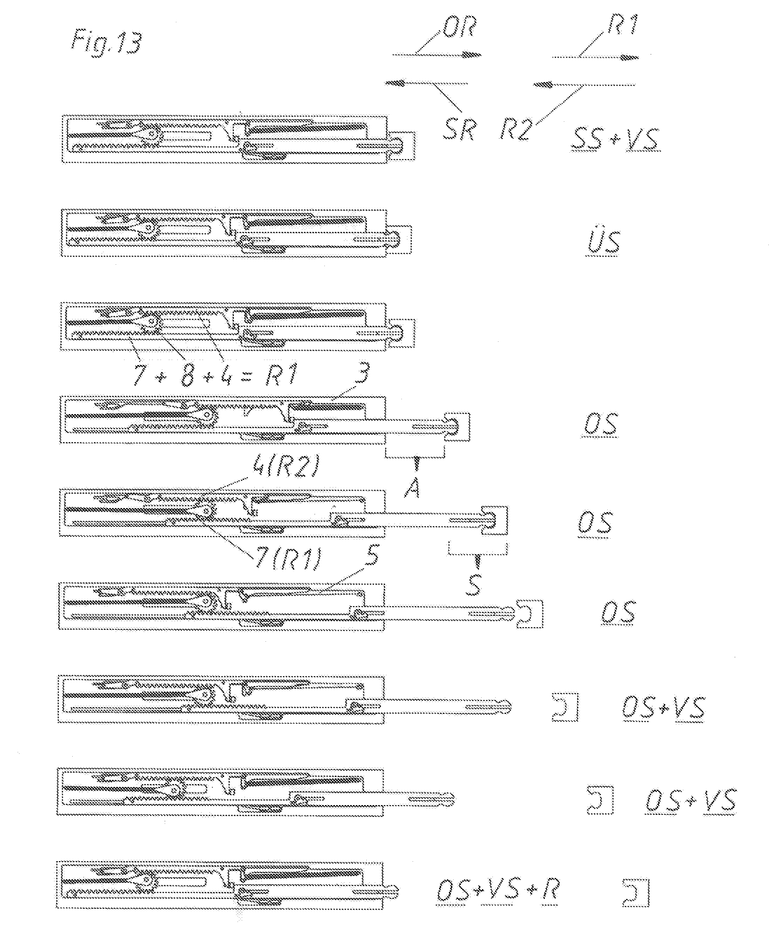

FIG. 13 shows in an overview the movement sequence of the ejection device on one side.

FIG. 1a shows an item of furniture 21 with a furniture carcass 22 and a movable furniture part 2 in the form of a furniture door. The movable furniture part is pivotally supported on the furniture carcass 22 by means of two hinges 23. A retracting device (not shown) for the movable furniture part 2 can be integrated in one of these hinges 23. An ejection device 1 is arranged on the furniture carcass 22 on a position remote from the hinges 23. In this case it can be seen that the ejection device 1 comprises a coupling piece 25 on an end facing towards the movable furniture part 2. This coupling piece 25 can be coupled with a coupling counter piece 24 arranged on the movable furniture part 2. In this FIG. 1a the movable furniture part 2 is an open position OS.

FIG. 1b shows an item of furniture 21 with a furniture carcass 22 and three movable furniture parts 2 in the form of drawers. The drawers are displaceably supported on the furniture carcass 22 by means of drawer extension guides. An ejection device 1 for ejecting the drawers into an open position OS (see top drawer) is arranged on the furniture carcass 22. The ejection device 1 can also be arranged on the drawer itself or on a rail of the extension guide.

1. An ejection device for a movable furniture part, comprising a carrier, in particular formed as a housing,
an ejection element for ejecting the movable furniture part from a closed position into an open position along an ejection path,
an ejection force storage member force-actuating the ejection element in the opening direction of the movable furniture part, wherein the ejection force storage member on the one hand engages the carrier and on the other hand engages the ejection element, and
a tensioning device for tensioning the ejection force storage member, wherein the tensioning device comprises a tensioning element, which can be coupled to the movable furniture part, and a, in particular rotatable, movement transmission element between the tensioning element and the ejection element, wherein the tensioning element and the ejection element can be moved in opposite directions in a coupled manner by the movement transmission element when the ejection force storage member is tensioned,
wherein the ejection element, the movement transmission element and the tensioning element can be moved together relative to the carrier at least over a first part of the ejection path.

2. The ejection device according to claim 1, wherein the ejection element, the movement transmission element and the tensioning element can be moved together relative to the carrier over the whole ejection path, preferably for the same distance and without a relative movement to each other.

3. The ejection device according to claim 1, wherein the ejection element, the movement transmission element and the tensioning element are, preferably linearly, displaceable together along a guide track formed in the carrier and comprising two end abutments.

4. The ejection device according to claim 3, wherein the movement transmission element abuts an end abutment of the guide track when the ejection force storage member is tensioned.

5. The ejection device according to claim 1, wherein the movement transmission element is formed as a gear wheel.

6. The ejection device according to claim 1, wherein the tensioning element and the ejection element each comprise a gear rack.

7. The ejection device according to claim 5, wherein, when the ejection force storage member is tensioned, the gear rack of the tensioning element and the gear rack of the ejection element mesh with the movement transmission element formed as a gear wheel and are movable, preferably in the form of a 1:1-transmission ratio, in opposite directions in a coupled manner by the movement transmission element.

8. The ejection device according to claim 1, wherein a retrieving device for moving the tensioning element in a retrieved position, wherein the retrieving device comprises a retrieving element, which can be coupled to the tensioning element, and a retrieving force storage member force-actuating the retrieving element.

9. The ejection device according to claim 8, wherein the retrieving element is integrally formed with the movement transmission element.

10. The ejection device according to claim 9, wherein the retrieving element comprises a slider and the movement transmission element formed as a gear wheel and being rotatably supported in the slider.

11. The ejection device according to claim 8, wherein the retrieving element is displaceably supported in a limited manner in the guide track comprising two end abutments and formed in the carrier.

12. The ejection device according to claim 1, wherein the ejection force storage member can be tensioned by the tensioning device when pulling the movable furniture part in the opening direction, preferably along a tensioning path following the ejection path.

13. The ejection device according to claim 1, characterized by wherein a locking device for locking the ejection element in a locking position, wherein the locking device can be unlocked by over-pressing the movable furniture part into an over-pressed position located behind the closed position.

14. The ejection device according to claim 13, wherein the locking device comprises a, preferably cardioid-shaped, sliding guide track formed in the carrier, a control lever movably, preferably rotatably, supported on the ejection element and a control pin arranged on the control lever and engaging the sliding guide track.

15. An item of furniture, comprising a furniture carcass, a movable furniture part and an ejection device according to claim 1 for the movable furniture part.

16. The item of furniture according to claim 15, wherein the movable furniture part is formed as a furniture door, wherein the furniture door is pivotally supported on the furniture carcass by means of two hinges and the ejection device is arranged on a position distanced to the hinges.

17. The item of furniture according to claim 16, wherein the ejection device is arranged in a region of the furniture carcass opposite to the hinges.
